(19) United States
(12) Patent Application Publication
(10) Pub. No.: US 2016/0079793 A1
(43) Pub. Date: Mar. 17, 2016

(54) WIRELESS POWER RECEIVER AND WIRELESS POWER TRANSMISSION AND RECEPTION SYSTEM

(71) Applicant: SAMSUNG ELECTRO-MECHANICS CO., LTD., Suwon-Si (KR)

(72) Inventors: Sang Ho CHO, Suwon-Si (KR); Hyung Wook CHO, Suwon-Si (KR); Sung Heum PARK, Suwon-Si (KR); Chang Mok HAN, Suwon-Si (KR); Jae Suk SUNG, Suwon-Si (KR); Jeong Man HAN, Suwon-Si (KR); Ki Won CHANG, Suwon-Si (KR)

(73) Assignee: SAMSUNG ELECTRO-MECHANICS CO., LTD., Suwon-Si (KR)

(21) Appl. No.: 14/713,168

(22) Filed: May 15, 2015

(30) Foreign Application Priority Data
Sep. 11, 2014 (KR) 10-2014-0120117

(51) Int. Cl. H02J 7/02; H02J 5/00

(52) U.S. Cl. CPC H02J 7/025; H02J 5/005

(57) ABSTRACT

A wireless power receiver may include a case formed of metal; and an insulator insulating one surface of the case to form at least two receiving electrodes. The at least two receiving electrodes form a capacitor in combination with at least two transmitting electrodes and receive power transmitted from the at least two transmitting electrodes.

### CROSS-REFERENCE TO RELATED APPLICATION

This application claims priority to, and the benefit of Korean Patent Application No. 10-2014-0120117 filed on Sep. 11, 2014, with the Korean Intellectual Property Office, the disclosure of which is incorporated herein by reference.

### BACKGROUND

This application relates to a wireless power receiver and a wireless power transmission and reception system.

In order to supply power to an electronic device, a power supply for transferring power from an external power source to the electronic device is required.

In general, a wired-type power supply which is directly connected to the electronic device by a connector, or the like, to supply power to a battery provided in such an electronic device is mainly used. Alternatively, as in the related art disclosed in the following Related Art Document, power may be supplied to a battery provided in an electronic device in a wireless manner using a magnetic induction effect or a magnetic resonance effect.

Recently, electronic devices have been provided with metal cases, instead of existing plastic cases, for product differentiation and aesthetic improvement of product design. However, since the magnetic resistance of metal is significantly less than that of air, commercialized wireless charging technologies using magnetic induction and magnetic resonance may not be used for electronic devices including metal cases.

### RELATED ART DOCUMENT

(Patent Document 1) Korean Patent Laid-Open Publication No. 10-2011-0009227

### SUMMARY

An exemplary embodiment in the present disclosure may provide a wireless power receiver and a wireless power transmission and reception system capable of wirelessly receiving power even in a case in which a product has a case formed of metal.

According to an exemplary embodiment in the present disclosure, a wireless power receiver may include: a case formed of metal; and an insulator insulating one surface of the case to format least two receiving electrodes, wherein the at least two receiving electrodes form a capacitor in combination with at least two transmitting electrodes and receive power transmitted from the at least two transmitting electrodes.

According to an exemplary embodiment in the present disclosure, a wireless power receiver may include: a receiving electrode part forming a capacitor in combination with a transmitting electrode and receiving power; and a battery part charged with power transferred from the receiving electrode part, wherein the receiving electrode part is provided as a case formed of metal and accommodating the battery part.

According to an exemplary embodiment in the present disclosure, a wireless power transmission and reception system may include: a wireless power transmitter including a power converting part converting input power and a transmitting electrode part receiving power from the power converting part; and a wireless power receiver including a receiving electrode part forming a capacitor in combination with the transmitting electrode part and receiving the power and a battery part charged with power transferred from the receiving electrode part, wherein the receiving electrode part is provided as a case formed of metal and accommodating the battery part.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view illustrating an exterior appearance of a wireless power transmission and reception system according to an exemplary embodiment in the present disclosure;

FIG. 2 is a perspective view of a wireless power transmitter according to an exemplary embodiment in the present disclosure;

FIGS. 3A and 3B are perspective views of a wireless power receiver according to an exemplary embodiment in the present disclosure;

FIGS. 4 and 5 are diagrams illustrating various examples of a receiving electrode part of the wireless power receiver according to exemplary embodiments of the present disclosure;

FIG. 6 is a block diagram of a wireless power transmission and reception system according to an exemplary embodiment in the present disclosure; and

FIG. 7 is a circuit diagram of the wireless power transmission and reception system according to an exemplary embodiment in the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

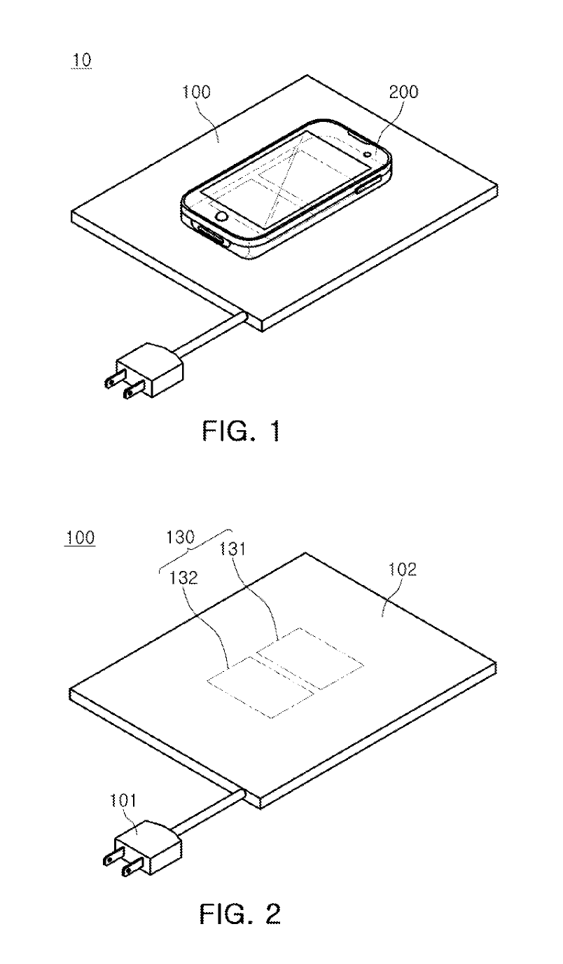

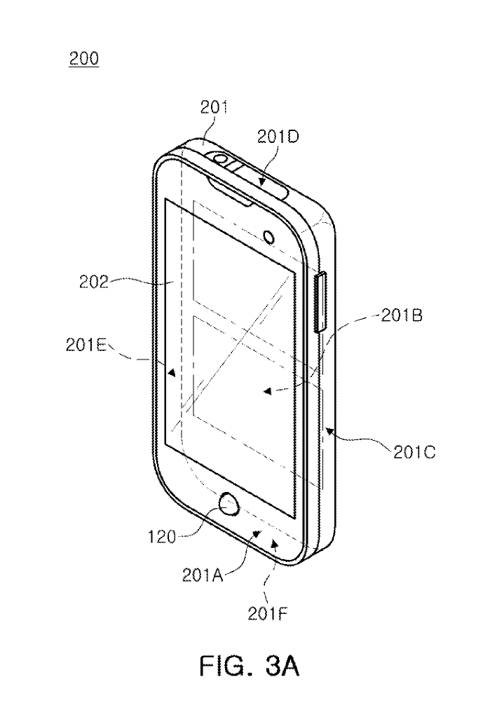

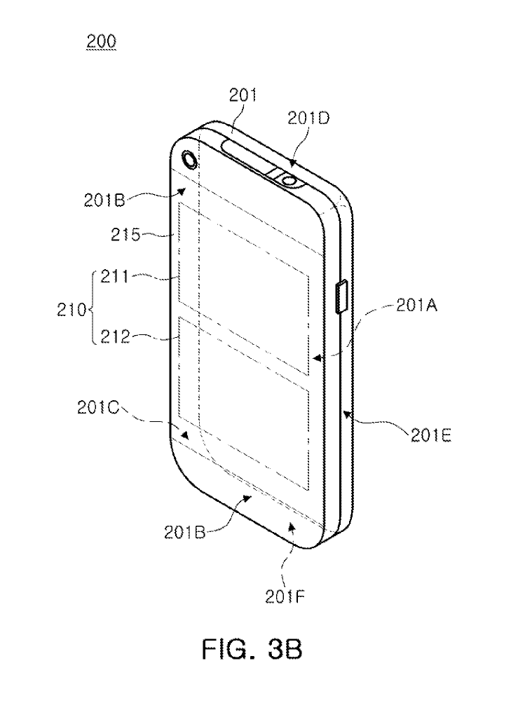

FIG. 1 is a perspective view illustrating an exterior appearance of a wireless power transmission and reception system according to an exemplary embodiment in the present disclosure, FIG. 2 is a perspective view of a wireless power transmitter according to an exemplary embodiment in the present disclosure, and FIGS. 3A and 3B are perspective views of a wireless power receiver according to an exemplary embodiment in the present disclosure.

Referring to FIG. 1, a wireless power transmission and reception system according to an exemplary embodiment may include a wireless power transmitter 100 and a wireless power receiver 200. The wireless power receiver 200 may be held by the wireless power transmitter 100.

Referring to FIGS. 1 and 2, the wireless power transmitter 100 may include a power terminal 101, a transmitting electrode part 130, and a housing 102. Although not shown, the wireless power transmitter 100 may further additionally include a power converting part including a switching part and a transforming part in the hosing 102.

The power terminal 101 may receive input power from an exterior power source and provide the input power to the power converting part, and the power converting part may perform a power converting operation of the input power so as to transfer the converted input power to the transmitting electrode part 130.

The transmitting electrode part 130 may include at least two transmitting electrodes 131 and 132. Specifically, the transmitting electrode part 130 may include a first transmitting electrode 131 and a second transmitting electrode 132, and the first transmitting electrode 131 and the second transmitting electrode 132 may be insulated from each other and be accommodated in the housing 102. The first transmitting electrode 131 and the second transmitting electrode 132 may be accommodated in the housing a state in which the first transmitting electrode 131 and the second transmitting electrode 132 are spaced apart from a top surface of the housing 102 by a predetermined thickness. Although the first transmitting electrode 131 and the second transmitting electrode 132 are shown in a quadrangular shape in FIG. 2, the first transmitting electrode 131 and the second transmitting electrode 132 may be modified in various shapes such as a triangular shape, a circular shape, and the like.

The housing 102 may be connected to the power terminal 101 and may accommodate the first transmitting electrode 131 and the second transmitting electrode 132. The housing 102 may be formed of an insulating material.

Referring to FIGS. 1, 3A and 3B, the wireless power receiver 200 may include a case 201. Although not shown, the wireless power receiver 200 may further include a rectifying part and a battery part in the case 201.

According to an exemplary embodiment, the wireless power receiver 200 may be a metal case of which most surfaces are formed of metal.

The case 201 may form an exterior appearance of the wireless power receiver 200, and when the case 201 has is very thin, the case 201 may include at least two surfaces. In this case, one surface of the at least two surfaces of the case 201 may be configured to have regions divided by metal and an insulating material.

The metal material may occupy a large portion of one surface and the insulating material may partition the metal material into at least two regions. The at least two regions of the metal material partitioned by the insulating material may be insulated from each other. According to the present exemplary embodiment, the at least two regions insulated by the insulating material may form a receiving electrode part 210, which may receive power from the wireless power transmitter 100 in a capacitive non-contact receiving type.

By way of example, the wireless power receiver 200 may be a mobile electronic device, and generally, a case forming an exterior appearance of a mobile electronic device may have a hexahedral shape or a modified hexahedral shape.

As shown in FIGS. 3A and 3B, in a case in which the case 201 has a hexahedral shape, the case 201 may include first and second main surfaces 201A and 201B, and first to fourth side surfaces 201C, 201D, 201E, and 201F. Since a display device 202 outputting an image is mounted on the entirety of any one of the first and second main surfaces 201A and 201B, the receiving electrode part 210 may be formed on the other surface of the case opposing one surface of the case on which the display device 202 is mounted.

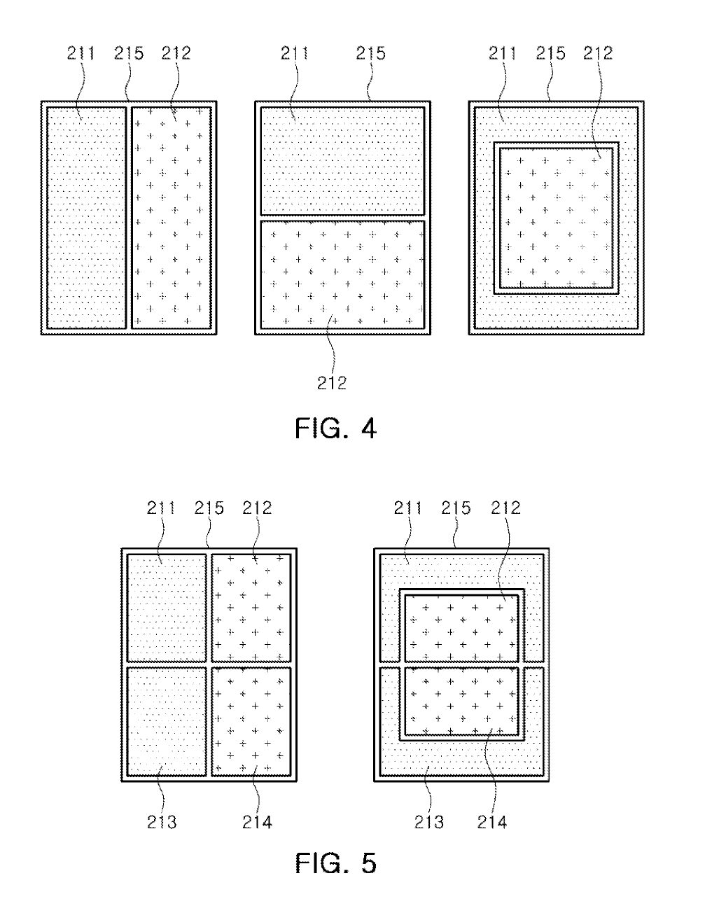

FIGS. 4 and 5 are diagrams illustrating various examples of the receiving electrode part of the wireless power receiver 200 according to exemplary embodiments of the present disclosure.

FIGS. 4 and 5 show any one of the main surfaces of the case 201 including at least two receiving electrodes 211, 212, 213 and 214, and an insulator 215.

FIG. 4 illustrates an example of the receiving electrode part in which two receiving electrodes are configured, wherein a first receiving electrode 211 and a second receiving electrode 212 may be partitioned in the insulator 215 so as to be insulated from each other. In this case, the first receiving electrode 211 and the second receiving electrode 212 may be modified in various shapes such as a triangular shape and a circular shape in addition to a quadrangular shape and a shape of “ [symbol] ” shown in FIG. 4.

FIG. 5 illustrates an example of the receiving electrode part in which four receiving electrodes are configured, wherein a first receiving electrode 211, a second receiving electrode 212, a third receiving electrode 213, and a fourth receiving electrode 214 may be partitioned in the insulator 215 so as to be insulated from one another. In this case, the first receiving electrode 211 and the second receiving electrode 212 may be modified in various shapes such as a triangular shape and a circular shape, in addition to a quadrangular shape and a shape of “ [symbol] ” shown in FIG. 4.

The first to fourth receiving electrodes 211, 212, 213, and 214 shown in FIGS. 4 and 5 may form a capacitor in combination with the first and second transmitting electrodes 131 and 132 shown in FIG. 2. In order to achieve high power transfer efficiency, the shapes of the receiving electrodes and the transmitting electrodes and the number of receiving electrodes and transmitting electrodes may correspond to each other.

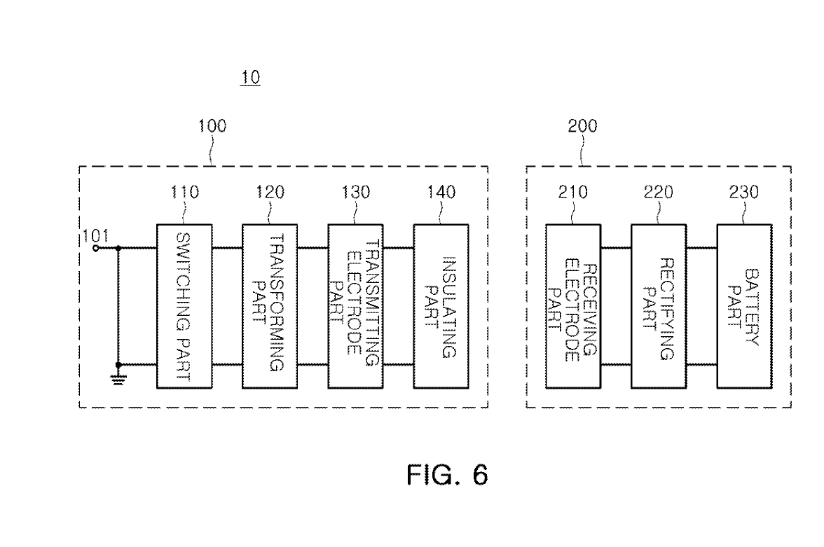

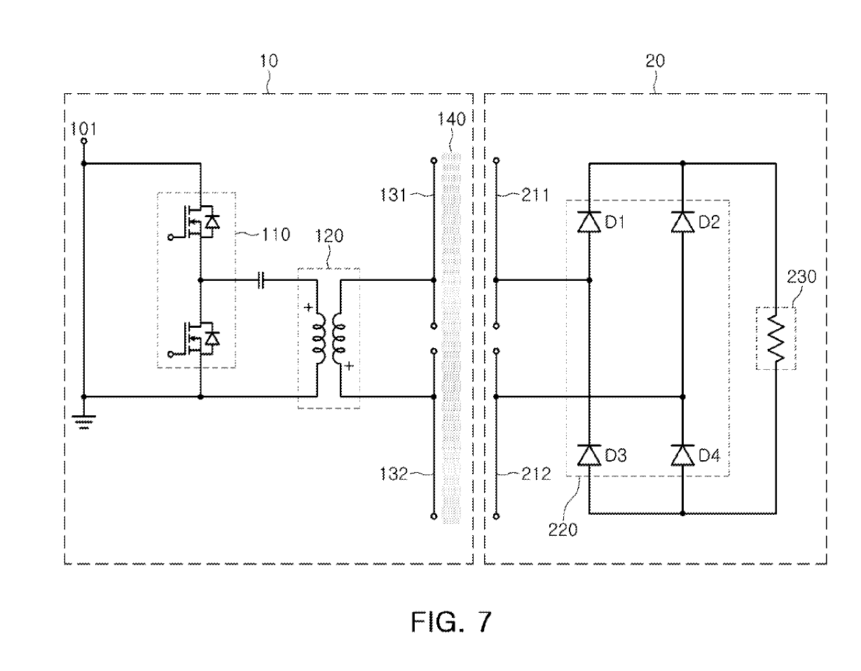

FIG. 6 is a block diagram of a wireless power transmission and reception system according to an exemplary embodiment in the present disclosure and FIG. 7 is a circuit diagram of the wireless power transmission and reception system according to an exemplary embodiment in the present disclosure. Hereinafter, the configuration and operation of the wireless power transmission and reception system according to an exemplary embodiment will be described with reference to FIGS. 6 and 7.

The wireless power transmission and reception system according to an exemplary embodiment in the present disclosure may include the wireless power transmitter 100 and the wireless power receiver 200.

The wireless power transmitter 100 may include a switching part 110, a transforming part 120, a transmitting electrode part 130, and an insulating part 140.

The switching part 110 may switch input power Vin input through the power terminal 101. The switching part 110 may include at least two switching elements M1 and M2, and the at least two switching elements M1 and M2 may be connected to each other in series and may alternately switch the input power Vin.

Although not shown in FIGS. 6 and 7, the wireless power transmitter 100 and the wireless power receiver 100 may each include a communicating part, and the switching part 110 may control at least one of a switching duty and a frequency of the at least two switching elements M1 and M2 according to power information received by the wireless power receiver 200.

The transforming part 120 may transform a voltage level of the switched power transferred from the switching part 110. The transforming part 120 may include a primary winding L1 and a secondary winding L2, wherein the primary winding L1 may be connected in parallel to the switching element M2 and the secondary winding L2 may be connected to the transmitting electrode part 130.

The primary winding L1 and the secondary winding L2 may be inductively coupled to each other according to a preset turns ratio and may change the voltage level of power applied to the primary winding L1 so as to output the changed voltage level to the secondary winding L2.

The transmitting electrode part 130 may receive the transformed power output from the transforming part 120 and may transmit the transformed power to the receiving electrode part 210 of the wireless power receiver 200 in a capacitive non-contact transmission manner. The transmitting electrode part 130 may include two transmitting electrodes 131 and 132, wherein a first transmitting electrode 131 may be connected to one end of the secondary winding L2 and a second transmitting electrode 132 may be connected to the other end of the secondary winding L2.

The insulating part 140 may serve as a dielectric layer in transmitting the power between the transmitting electrode part 130 and the receiving electrode part 210 in the capacitive non-contact transmission manner. In this case, the housing 102 shown in FIG. 1 may serve as the insulating part 140.

The wireless power receiver 200 may include a receiving electrode part 210, a rectifying part 220, and a battery part 230.

The receiving electrode part 210 may receive the power from the transmitting electrode part 130. The receiving electrode part 210 may include at least two receiving electrodes 211 and 212. The first receiving electrode 211 and the second receiving electrode 212 may be disposed to face the first transmitting electrode 131 and the second transmitting electrode 132, respectively. The receiving electrode part 210 may transfer the received power to the rectifying part 220.

The rectifying part 220 may include one or more diode elements D1, D2, D3, and D4 so as to rectify the power received from the receiving electrode part 210. The rectifying part 220 may include first to fourth diodes D1, D2, D3, and D4, wherein the first to fourth diodes D1, D2, D3, and D4 may perform full-wave rectification for the power received from the receiving electrode part 210 so as to transfer the full-wave rectified power to the battery part 230. The battery part 230 may be charged with the power transferred from the rectifying part 220.

As set forth above, according to exemplary embodiments of the present disclosure, power may be wirelessly transmitted and received even in a case in which a case is formed of metal.

While exemplary embodiments have been shown and described above, it will be apparent to those skilled in the art that modifications and variations could be made without departing from the scope of the present invention as defined by the appended claims.

What is claimed is:

1. A wireless power receiver comprising:
a case formed of metal; and
an insulator insulating one surface of the case to form at least two receiving electrodes,
wherein the at least two receiving electrodes form a capacitor in combination with at least two transmitting electrodes and receive power transmitted from the at least two transmitting electrodes.

2. The wireless power receiver of claim 1, further comprising a battery part charged with power transferred from the at least two receiving electrodes.

3. The wireless power receiver of claim 1, further comprising a rectifying part rectifying power transferred from the at least two receiving electrodes.

4. The wireless power receiver of claim 1, wherein each of the at least two receiving electrodes forms a separate capacitor with each of the at least two transmitting electrodes.

5. A wireless power receiver comprising:
a receiving electrode part forming a capacitor in combination with a transmitting electrode and receiving power; and
a battery part charged with power transferred from the receiving electrode part,
wherein the receiving electrode part is provided as a case formed of metal and accommodating the battery part.

6. The wireless power receiver of claim 5, wherein the receiving electrode part includes at least two receiving electrodes.

7. The wireless power receiver of claim 6, further comprising an insulator insulating the case to form the at least two receiving electrodes.

8. A wireless power transmission and reception system comprising:
a wireless power transmitter including a power converting part converting input power and a transmitting electrode part receiving power from the power converting part; and
a wireless power receiver including a receiving electrode part forming a capacitor in combination with the transmitting electrode part and receiving the power, and a battery part charged with power transferred from the receiving electrode part,
wherein the receiving electrode part is provided as a case formed of metal and accommodating the battery part.

9. The wireless power transmission and reception system of claim 8, wherein the transmitting electrode part includes at least two transmitting electrodes,
the receiving electrode part includes at least two receiving electrodes, and
each of the at least two receiving electrodes forms a separate capacitor with each of the at least two transmitting electrodes.

10. The wireless power transmission and reception system of claim 9, wherein the wireless power receiver further includes an insulator insulating the case to form the at least two receiving electrodes.

11. The wireless power transmission and reception system of claim 8, wherein the wireless power transmitter further includes a housing accommodating the transmitting electrode part, and
the housing forms a dielectric layer of the capacitor formed by the transmitting electrode part and the receiving electrode part.

12. The wireless power transmission and reception system of claim 8, wherein the power converting part includes:
a switching part including at least two switching elements and switching the input power; and
a transforming part including a primary winding and a secondary winding which are inductively coupled to each other according to a preset turns ratio and converting a voltage level of power transferred from the switching part.

13. The wireless power transmission and reception system of claim 12, wherein the switching part controls at least one of a duty and a frequency of the at least two switching elements according to power information received by the receiving electrode part.
